(19) United States
(12) Patent Application Publication
(10) Pub. No.: US 2019/0262918 A1
(43) Pub. Date: Aug. 29, 2019

(54) Laser Assisted Tile Cutting Device

(71) Applicant: Joseph W. DeSantis, North Providence, RI (US)

(72) Inventor: Joseph W. DeSantis, North Providence, RI (US)

(21) Appl. No.: 16/040,201

(22) Filed: Jul. 19, 2018

Related U.S. Application Data
(60) Provisional application No. 62/635,047, filed on Feb. 26, 2018.

(51) Int. Cl. B23D 59/00; B26B 29/06

(52) U.S. Cl. CPC B23D 59/003; B26B 29/06

(57) ABSTRACT

A laser assisted tile cutting device consists of a base section, cutting unit, a laser beam emitting unit, a pair of guide rails, a sliding mechanism, a first mounting pad, and a second mounting pad. The first mounting pad and the second mounting pad, which are aligned parallel to each other, are perpendicularly mounted onto the base section. The pair of guide rails extend from the first mounting pad to the second mounting pad. The cutting unit is slidably positioned along the pair of guide rails via the sliding mechanism. The laser beam emitting unit generates a guided path for the cutting unit to follow. By following the guided path, accurate linear cuts and angular cuts can be obtained.

The current application claims a priority to the U.S. Provisional Patent application Ser. No. 62/635,047 filed on Feb. 26, 2018.

### FIELD OF THE INVENTION

The present invention relates generally to hand tools and construction tools. More specifically, the present invention relates to laser-assisted construction hand tools.

### BACKGROUND OF THE INVENTION

Tiles are one of the most often used construction materials. From residential to commercial construction, tiles are used for covering surfaces, providing ornamental designs to finished structures, etc. In general, a tile is provided in pre-manufactured shapes and sizes, which oftentimes does not fit or match the size and/or shape of the space where the tile is to be placed. As a result, the user cuts the tile into the necessary size and/or shape so the tile fits into the intended space. There are currently various devices available which allow the user to cut pieces of tile. Due to the material properties of tiles, electrical tile cutters are widely used. The electrical tile cutters provide a base where the tile is placed with a cutting structure secured to the base. The cutting structure is electrically powered and allows for faster and more efficient cutting. While the electrical tile cutters offer many benefits, these devices are restricted to the availability of electricity. In addition, these devices can be heavy and difficult to transport. As a solution, manual tile cutters are often utilized as replacements. Manual tile cutters often provide the same structure: a base with a cutting mechanism. While manual tile cutters are easier to transport and use than electrical tile cutters, manual tile cutters can often provide less accurate cuts. Because the user is required to apply force in order for the cutting mechanism of the manual tile cutter to work, the user can easily fail to cut in straight lines. Some manual tile cutters provide guidelines or similar mechanisms to aid in the cutting process. However, due to the large range of tile shapes and sizes, these guiding mechanisms can often be ineffective and useless. Thus, a manual tile cutter with a more efficient guide mechanism that allows the user to perform more precise and straight cuts is beneficial and necessary.

An objective of the present invention is to provide a laser assisted tile cutter which is a manual tile cutter with an integrated laser guide. Another objective of the present invention is to provide a laser assisted tile cutter which allows the user to perform more precise and straight cuts. Another objective of the present invention is to provide a laser assisted tile cutter which comprises an easy to use and easy to transport structure. Additional advantages of the invention will be set forth in part in the description which follows, and in part will be obvious from the description, or may be learned by practice of the invention. Additional advantages of the invention may be realized and attained by means of the instrumentalities and combinations particularly pointed out in the detailed description of the invention section. Further benefits and advantages of the embodiments of the invention will become apparent from consideration of the following detailed description given with reference to the accompanying drawings, which specify and show preferred embodiments of the present invention.

### BRIEF DESCRIPTION OF THE DRAWINGS

FIG. 1A is a perspective view of the present invention, wherein the cutting unit is in a start position.

FIG. 1B is a side view of the present invention, wherein the cutting unit is in the start position.

FIG. 2A is a perspective view of the present invention, wherein the cutting unit is in an end position.

FIG. 2B is a side view of the present invention, wherein the cutting unit is in the end position.

FIG. 3 is another side view of the present invention, wherein the cutting unit is in the end position.

FIG. 4 is a perspective exploded view of the cutting unit and the base section.

FIG. 5 is a top view of the base section, the first mounting pad, the second mounting pad, and the pair of guide rails.

FIG. 6 is a perspective view of the cutting unit.

### DETAIL DESCRIPTIONS OF THE INVENTION

All illustrations of the drawings are for the purpose of describing selected versions of the present invention and are not intended to limit the scope of the present invention.

The present invention introduces a laser assisted tile cutting device. In contrast to existing manual tile cutting devices, the present invention provides greater accuracy levels and provides a greater level of convenience when cutting tiles at angles and varying shapes.

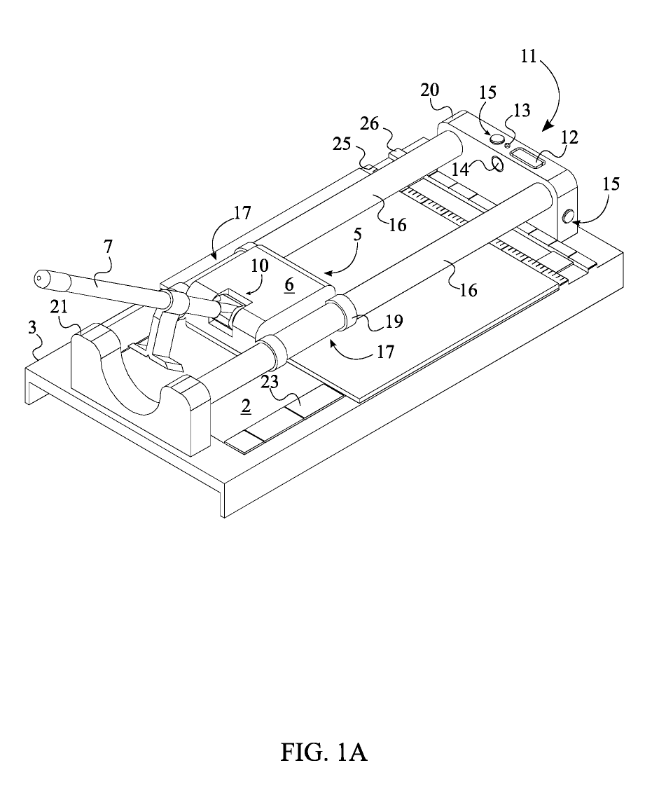

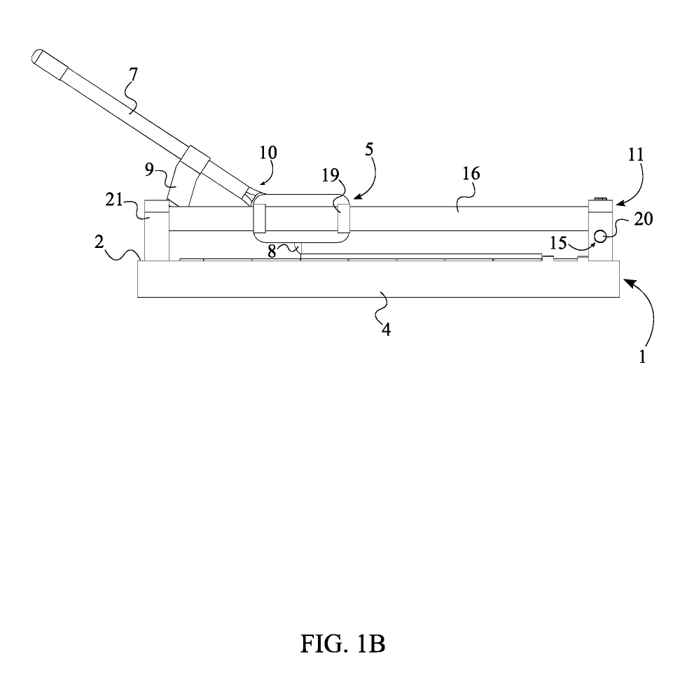

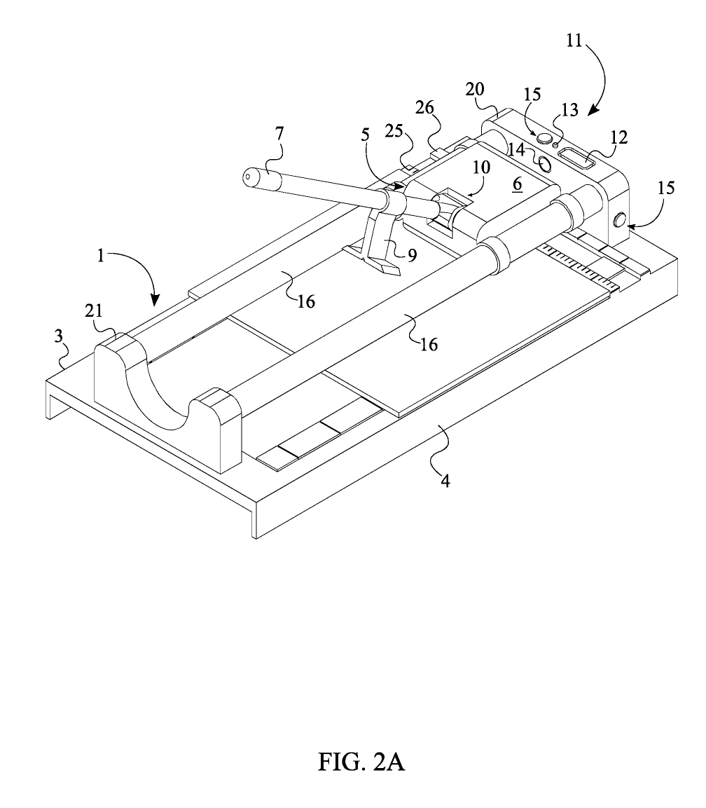

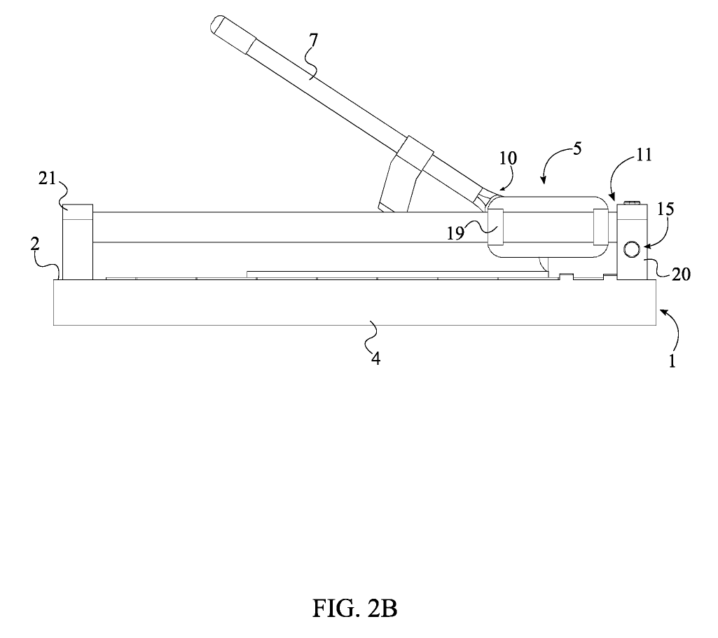

As seen in FIGS. 1A-2B, to achieve the intended functionalities, the present invention comprises a base section 1, a cutting unit 5, a laser beam emitting unit 11, a pair of guide rails 16, a sliding mechanism 17, a first mounting pad 20, and a second mounting pad 21. When the present invention is in use, a tile that needs to be cut is initially positioned atop the base section 1. Next, the cutting unit 5 is moved along the pair of guide rails 16 while being guided by the laser beam emitting unit 11. The sliding mechanism 17 allows the cutting unit 5 to move along the pair of guide rails 16. The base section 1 can vary in size and shape in different embodiments of the present invention. A top receiving surface 2 of the base section 1 is utilized to place the tile that needs to be cut. The first mounting pad 20 and the second mounting pad 21 are used to position the pair of guide rails 16 above the tile, and thus, position the cutting unit 5 in a mechanically advantageous position to score the tile. To do so, the first mounting pad 20 and the second mounting pad 21 are perpendicularly mounted onto the top receiving surface 2. The second mounting pad 21 is positioned opposite to the first mounting pad 20 across the base section 1. The overall distance between the first mounting pad 20 and the second mounting pad 21 can vary in different embodiments of the present invention. To position the pair of guide rails 16 in parallel with both the top receiving surface 2 and the tile placed on the top receiving surface 2, the first mounting pad 20 and the second mounting pad 21 are aligned parallel to each other. The overall height of the first mounting pad 20 and the second mounting pad 21 from the top receiving surface 2 can vary in different embodiments of the present invention.

As seen in FIG. 1A and FIG. 2A, the pair of guide rails 16 is used to slide the cutting unit 5 along the body of the tile. To do so, the pair of guide rails 16 extends from the first mounting pad 20 to the second mounting pad 21. A first rail of the pair of guide rails 16 is positioned in parallel to a second rail of the pair of guide rails 16. Thus, by utilizing the sliding mechanism 17, the cutting unit 5 can slide in between the first mounting pad 20 and the second mounting pad 21 and along the pair of guide rails 16. The sliding mechanism 17 can vary in different embodiments of the present invention.

The laser beam emitting unit 11 provides a guided path for the cutting unit 5 to follow. By following the guided path, the user is guaranteed to have a precise cut on the tile. Moreover, the laser beam emitting unit 11 improves the ability to cut the body of the tile at varying angles. To obtain the intended results, the laser beam emitting unit 11 is laterally mounted onto the first mounting pad 20 and oriented towards the second mounting pad 21. Thus, when the cutting unit 5 is pushed from the second mounting pad 21 towards the first mounting pad 20, the cutting unit 5 can be directed along the guided path provided by the laser beam emitting unit 11.

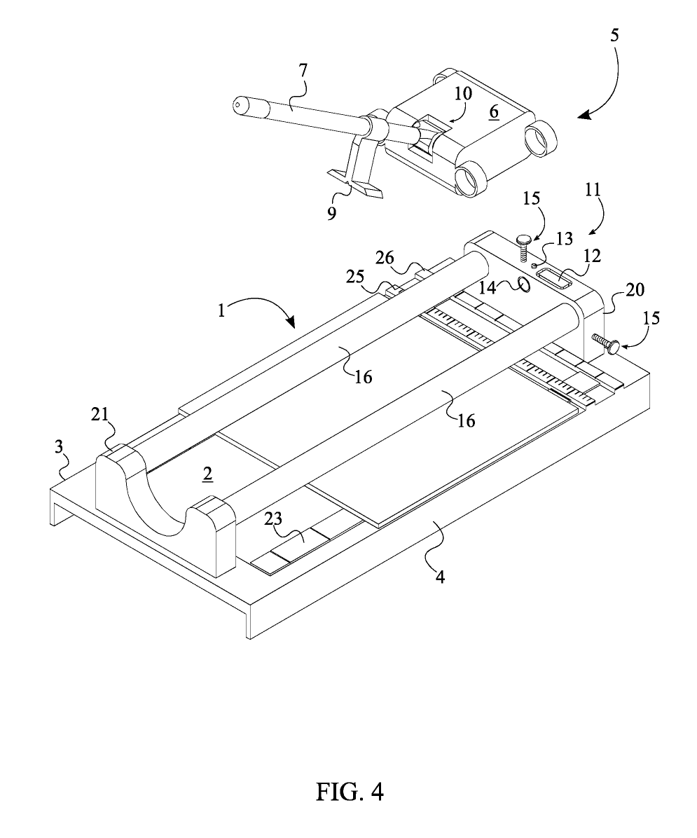

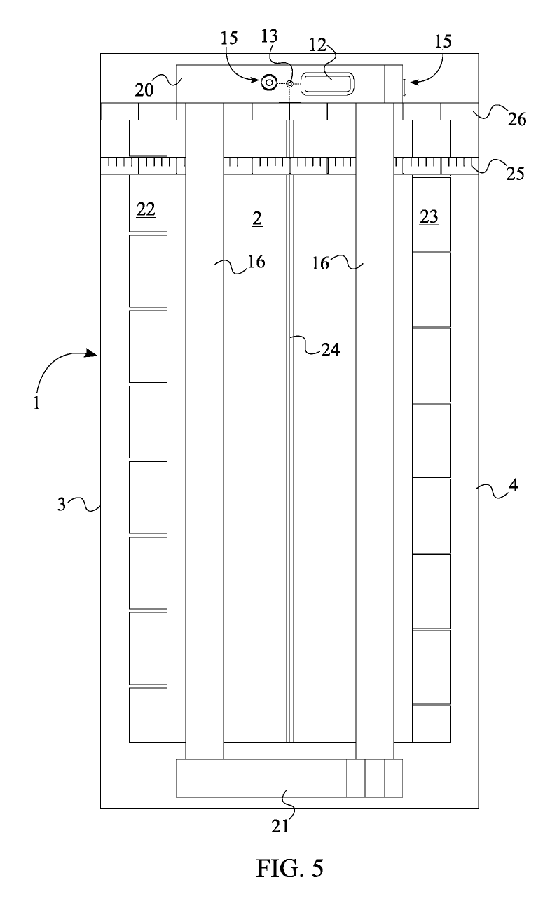

As seen in FIG. 4 and FIG. 5, in the preferred embodiment, the laser beam emitting unit 11 comprises a power source 12, a control switch 13, a laser diode 14, and a levelling mechanism 15. However, the laser beam emitting unit 11 can vary in different embodiments of the present invention. The power source 12 provides the electrical power required for functioning by being electrically connected to the control switch 13 and the laser diode 14. The control switch 13, which is externally mounted onto the first mounting pad 20 or other functional position, allows the user to switch on or switch off the laser diode 14. The levelling mechanism 15 allows the user to adjust the guided path as preferred. To do so, the laser diode 14 is mechanically engaged with the levelling mechanism 15 allowing the user to adjust the laser diode 14 along a vertical axis or a horizontal axis. By adjusting the laser diode 14 along the vertical axis, the present invention can be used with tiles of varying lengths. As an example, the present invention can be used with a 2-inch long tile and be used with a 48-inch long tile. On the other hand, by adjusting the laser diode 14 along a horizontal axis, the user can accommodate complex shapes and angles. In the preferred embodiment of the present invention, a set of levelling screws is used as the levelling mechanism 15. However, the levelling mechanism 15 can vary in different embodiments of the present invention.

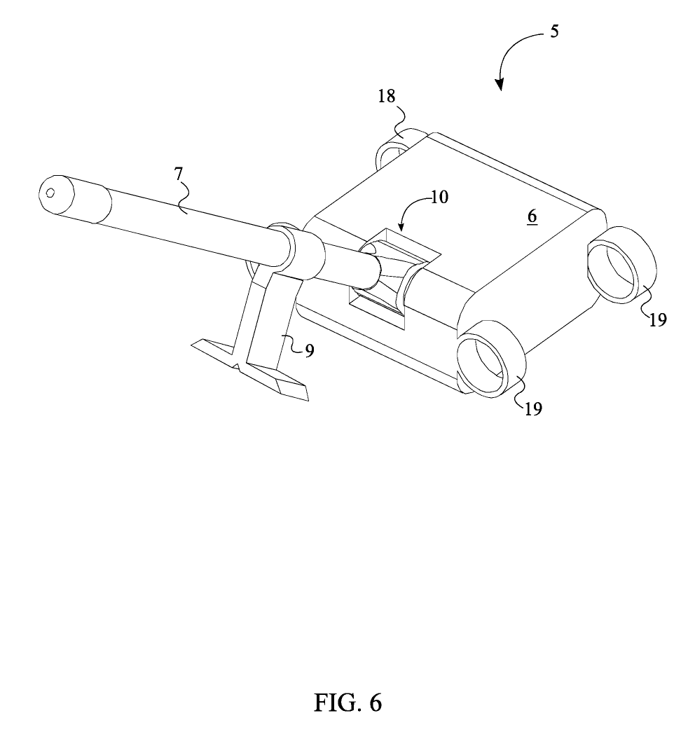

After the path for cutting is determined by the laser beam emitting unit 11, the cutting purposes are executed through the cutting unit 5 shown in FIG. 6. As further illustrated in FIG. 1B and FIG. 2B, in the preferred embodiment of the present invention, the cutting unit 5 comprises a housing 6, a handle 7, a cutting tip 8, a breaker pad 9, and a pivoting mechanism 10. The housing 6 functions as the structural body of the cutting unit 5. The cutting tip 8, which can vary in size and shape in different embodiments, is centrally connected to a bottom surface 60 of the housing 6 so that the cutting tip 8 can be pressed against the tile positioned on the top receiving surface 2. By being centrally connected to the housing 6, the cutting tip 8 is also positioned in between each of the pair of guide rails 16. When the cutting tip 8 is pressed against the tile, the cutting unit 5 is pushed along the pair of guide rails 16 from the second mounting pad 21 towards the first mounting pad 20. As a result, the cutting tip 8 scores a groove along the guided path generated by the laser beam emitting unit 11. The groove extending along the guided path determines the snapping line of the tile.

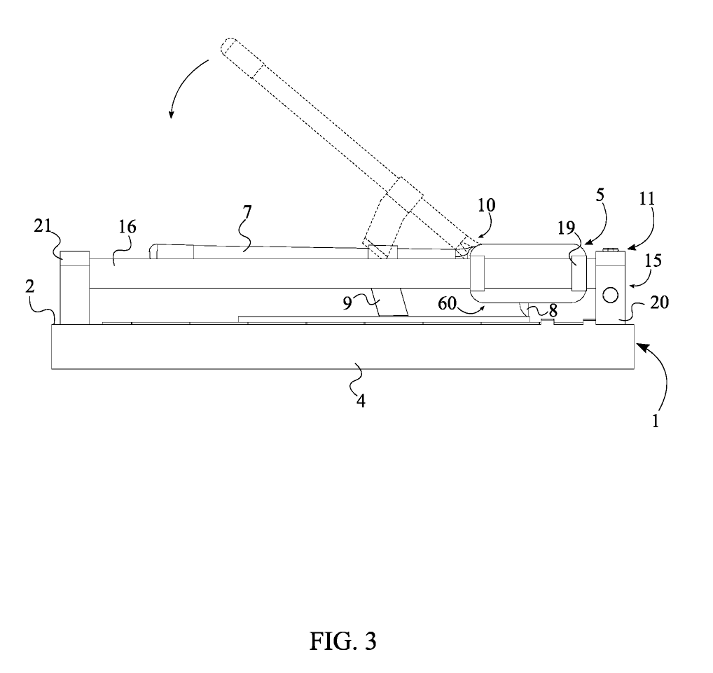

As shown in FIG. 3, the breaker pad 9, which is used to snap the tile along the groove, is controlled via the handle 7. To do so, the breaker pad 9 is mounted along the handle 7 and oriented towards the top receiving surface 2. For the breaker pad 9 to be in contact with the tile when needed, the handle 7 is pivotally connected to the housing 6 via the pivoting mechanism 10. Thus, the user can lower the handle 7 towards the top receiving surface 2 so that the breaker pad 9 presses against the tile resting on the top receiving surface 2. The pressure applied by the breaker pad 9 aids in snapping the tile along the groove.

As shown in FIG. 5, the present invention further comprises a first friction pad 22 and a second friction pad 23 that are used to provide a non-slip surface for the tile when being positioned on the top receiving surface 2. The first friction pad 22 and the second friction pad 23 can be made of rubber or other comparable frictional materials. The first friction pad 22 is positioned along a first lengthwise edge 3 of the base section 1. On the other hand, the second friction pad 23 is positioned along a second lengthwise edge 4 of the base section 1, wherein the second lengthwise edge 4 is positioned opposite the first lengthwise edge 3 along the base section 1. In the preferred embodiment, the base section 1 is rectangular in shape. Thus, the first lengthwise edge 3 is positioned in parallel to the second lengthwise edge 4.

As further illustrated in FIG. 5, to assist the breaker pad 9 in snapping the tile along the groove, the present invention further comprises a breaker strip 24. When snapping the tile along the groove, the breaker pad 9 applies downward pressure on either side of the groove. The breaker strip 24 is used to apply upward pressure along the groove of the tile. To do so, the breaker strip 24 is centrally mounted onto the top receiving surface 2. The breaker strip 24 is positioned in between the first friction pad 22 and the second friction pad 23. Moreover, the breaker strip 24 will also be positioned in parallel to the first lengthwise edge 3 and the second lengthwise edge 4.

The sliding mechanism 17 shown in FIG. 1A is used to move the cutting unit 5 along the pair of guide rails 16 and can vary from one embodiment to another. In the preferred embodiment, the sliding mechanism 17 comprises a first rail-receiving sleeve 18 and a second rail-receiving sleeve 19, as can be seen in FIG. 6. The first rail-receiving sleeve 18 is laterally connected to the housing 6. The second rail-receiving sleeve 19 is also laterally connected to the housing 6 opposite the first rail-receiving sleeve 18. To slidably engage the cutting unit 5 with the pair of guide rails 16, a first corresponding rail from the pair of guide rails 16 is sleeved by the first rail-receiving sleeve 18. Likewise, a second corresponding rail from the pair of guide rails 16 is sleeved by the second rail-receiving sleeve 19. In particular, the first rail-receiving sleeve 18 and the second rail-receiving sleeve 19 are slidably engaged with the pair of guide rails 16 to position the cutting tip 8 adjacent the top receiving surface 2.

When cutting a tile into different shapes and lengths, accuracy is vital. As shown in FIG. 4 and FIG. 5, to aid the user with measuring the tile, the present invention is provided with a linear index 25 that is positioned along the top receiving surface 2 adjacent the first mounting pad 20. Since the tile is also positioned on the top receiving surface 2, the linear index 25 can be effectively used to measure the tile for cutting purposes. Preferably, the linear index 25 is positioned perpendicular to the first lengthwise edge 3 and the second lengthwise edge 4. The positioning of the linear index 25 allows the user to press the tile against the linear index 25 and measure the tile as required.

As further illustrated in FIG. 4 and FIG. 5, the present invention further comprises an angular index 26 that allows to measure angles when cutting different shapes on tiles. The angular index 26 is positioned on the top receiving surface 2 and adjacent the linear index 25. Similar to the linear index 25, the angular index 26 is also positioned perpendicular to the first lengthwise edge 3 and the second lengthwise edge 4. When the angular index 26 is being used, the laser diode 14 is positioned such that the emitted laser beam intersects a marker of the angular index 26. Each marker of the angular index 26 corresponds to a predetermined angle from a midpoint of the angular index 26, wherein the midpoint is linearly aligned with the breaker strip 24 at the center of the top receiving surface 2. Therefore, when the tile is positioned adjacent the angular index 26, the emitted laser beam projects onto the tile at the predetermined angle.

When the present invention is in use, the following process flow is generally followed. Initially, the cutting unit 5 is positioned adjacent the second mounting pad 21. Next, the tile that needs to be cut is positioned on the top receiving surface 2. The linear index 25 is used if any measurements are required before cutting the tile. Next, the user activates the laser beam emitting unit 11 so that a laser beam is emitted onto the tile resulting in the guided path. If the tile needs to be cut at an angle, the angular index 26 is used. When the guided path is established, the user adjusts the tile so that the cutting tip 8 is aligned with the guided path. Next, the user pushes the cutting unit 5 towards the first mounting pad 20 along the pair of guide rails 16. As a result, the cutting tip 8 scores the groove on the tile. When the preferred groove is made, the user lowers the handle 7 towards the top receiving surface 2 so that the breaker pad 9 applies downward pressure on the tile. Simultaneously, the breaker strip 24 applies upward pressure on the tile so that the tile snaps along the groove.

Although the invention has been explained in relation to its preferred embodiment, it is to be understood that many other possible modifications and variations can be made without departing from the spirit and scope of the invention as hereinafter claimed.

What is claimed is:

1. A laser assisted tile cutting device comprises:
a base section;
a cutting unit;
a laser beam emitting unit;
a pair of guide rails;
a sliding mechanism;
a first mounting pad;
a second mounting pad;
the base section comprises a top receiving surface;
the first mounting pad being perpendicularly mounted onto the top receiving surface;
the second mounting pad being perpendicularly mounted onto the top receiving surface opposite the first mounting pad across the base section, wherein the first mounting pad is aligned parallel to the second mounting pad;
the pair of guide rails extending from the first mounting pad to the second mounting pad;
the laser beam emitting unit being laterally mounted onto the first mounting pad and oriented towards the second mounting pad; and
the cutting unit being slidably positioned along the pair of guide rails with the sliding mechanism.

2. The laser assisted tile cutting device as claimed in claim 1 further comprises:
the laser beam emitting unit comprises a power source, a control switch, a laser diode, and a levelling mechanism;
the power source being electrically connected to the control switch and the laser diode;
the control switch being externally mounted onto the first mounting pad; and
the laser diode being mechanically engaged with the levelling mechanism.

3. The laser assisted tile cutting device as claimed in claim 1 further comprises:
the cutting unit comprises a housing, a handle, a cutting tip, a breaker pad, and a pivoting mechanism;
the handle being connected to the housing through the pivoting mechanism;
the cutting tip being centrally connected to a bottom surface of the housing; and
the breaker pad being mounted along the handle and oriented towards the top receiving surface.

4. The laser assisted tile cutting device as claimed in claim 1 further comprises:
the sliding mechanism comprises a first rail-receiving sleeve and a second rail-receiving sleeve;
the first rail-receiving sleeve being laterally connected to a housing of the cutting unit;
the second rail-receiving sleeve being laterally connected to the housing opposite the first rail-receiving sleeve;
a first corresponding rail from the pair of guide rails being sleeved by the first rail-receiving sleeve; and
a second corresponding rail from the pair of guide rails being sleeved by the second rail-receiving sleeve.

5. The laser assisted tile cutting device as claimed in claim 1 further comprises:
a first friction pad;
a second friction pad;
the first friction pad being mounted onto the top receiving surface along a first lengthwise edge of the base section; and
the second friction pad being mounted onto the top receiving surface along a second lengthwise edge of the base section.

6. The laser assisted tile cutting device as claimed in claim 5 further comprises:
a breaker strip;
the breaker strip being centrally mounted onto a top receiving surface of the base section, wherein the breaker strip is in parallel to the first lengthwise edge and the second lengthwise edge; and
the breaker strip being positioned in between the first friction pad and the second friction pad.

7. The laser assisted tile cutting device as claimed in claim 1 further comprises:
a linear index;
the linear index being positioned on the top receiving surface adjacent the first mounting pad; and
the linear index being positioned perpendicular to a first lengthwise edge and a second lengthwise edge of the base section.

8. The laser assisted tile cutting device as claimed in claim 1 further comprises:
an angular index;
the angular index being positioned on the top receiving surface adjacent a linear index; and
the angular index being positioned perpendicular to a first lengthwise edge and a second lengthwise edge of the base section.
